(19) United States
(12) Patent Application Publication
(10) Pub. No.: US 2002/0042970 A1
(43) Pub. Date: Apr. 18, 2002

(54) Torsion-generating device

(76) Inventor: Chia Yu Liao, Taipei (TW)

Correspondence Address: Chia Yu Liao, 235 Chung - Ho, Box 8-24, Taipei, TW

(21) Appl. No.: 09/963,706

(22) Filed: Sep. 27, 2001

(30) Foreign Application Priority Data
Oct. 13, 2000 (TW) 89217777

(51) Int. Cl. E05D 11/08

(52) U.S. Cl. 16/337

(57) ABSTRACT

A torsion-generating device capable of assembling with a pivot shaft device is disclosed. By the torsion-generating device, the orientation of an object installed with the pivot shaft device is adjustable. The torsion-generating device comprises a first retaining unit and a second retaining unit. Each of the first retaining unit and second retaining unit comprise a plurality of first friction arms and a plurality of second friction arms. The friction arms extend axially and are parallel to each other; and a proper gap is formed between each two adjacent friction arms. The second friction arms are arranged with respect to the first friction arms. The first friction arms are connected by a first connecting portion, and the second friction arms are connected by a second connecting portion. Thereby, the torsion-generating device can be assembled to the pivot shaft device rapidly.

### FIELD OF THE INVENTION

The present invention relates to a torsion-generating device, and particularly to a torsion-generating device which is used with a pivot shaft device so that an object installed with the pivot shaft device can be adjusted steadily.

### BACKGROUND OF THE INVENTION

A pivot shaft device is installed to an object so that the orientation of the object is adjustable with respect to a body mounted the object. To cause the object to position at a determined position, a steady torsional force is generated between the object and the body by a friction force therebetween. Thereby, the object can be positioned at a selected angle. For example, a keyboard and a liquid crystal display of a notebook computer are installed with the pivot shaft device for controlling the angle therebetween.

In U.S. Pat. No. 5,697,125, a pivot shaft device is disclosed, wherein the pivot shaft device can generate a steady torsional force by a friction force. The pivot shaft device has a rotatable post, a plurality of annular thin plate elements capable of being inserted by the post and thus providing a steady torsional force, and a sleeve for fixing the annular thin plate elements. Two ends of the post are utilized to install an object (for example, liquid crystal screen of a notebook computer). The sleeve is installed in a body (for example, a keyboard of the notebook computer). If the angle between the screen and the keyboard is desired to be adjusted, the post can be positioned in a selected angle by the friction force between the outer surface of the post and the inner surfaces of the annular thin plate elements and the trosional force between the annular thin plate elements and the sleeve. Although above prior art provides a steady torsional force, to install the annular thin plate elements is complex and difficult so that the cost and time of assembly are increased.

### SUMMARY OF THE INVENTION

Accordingly, the primary object of the present invention is to provide a torsion-generating device, wherein an object installed in the pivot shaft may rotate and position to a desired orientation.

Another object of the present invention is to provide a torsion-generating device, wherein the assembly time and cost are reduced.

To achieve above objects, the present invention provides a torsion-generating device capable of being assembled with a pivot shaft device. Thereby, the orientation of an object installed to the pivot shaft device is adjustable. The torsion-generating device comprises a first retaining unit and a second retaining unit. Each of the first retaining unit and second retaining unit comprise a plurality of first friction arms and a plurality of second friction arms. The friction arms extend axially and are parallel to each other; and a proper gap is formed between each two adjacent friction arms. The second friction arms are arranged with respect to the first friction arms. The first friction arms are connected by a first connecting portion, and the second friction arms are connected by a second connecting portion. Thereby, the torsion-generating device can be assembled to the pivot shaft rapidly.

The various objects and advantages of the present invention will be more readily understood from the following detailed description when read in conjunction with the appended drawing.

### BRIEF DESCRIPTION OF THE DRAWINGS

FIG. 1 is a perspective view of the torsion generating device of the present invention.

FIG. 2 is an exploded view showing the assembly of the torsion generating device and a pivot shaft in the present invention.

FIG. 3 is an assembly view of the torsion generating device and the pivot shaft of the present invention.

### DETAILED DESCRIPTION OF THE PREFERRED EMBODIMENTS

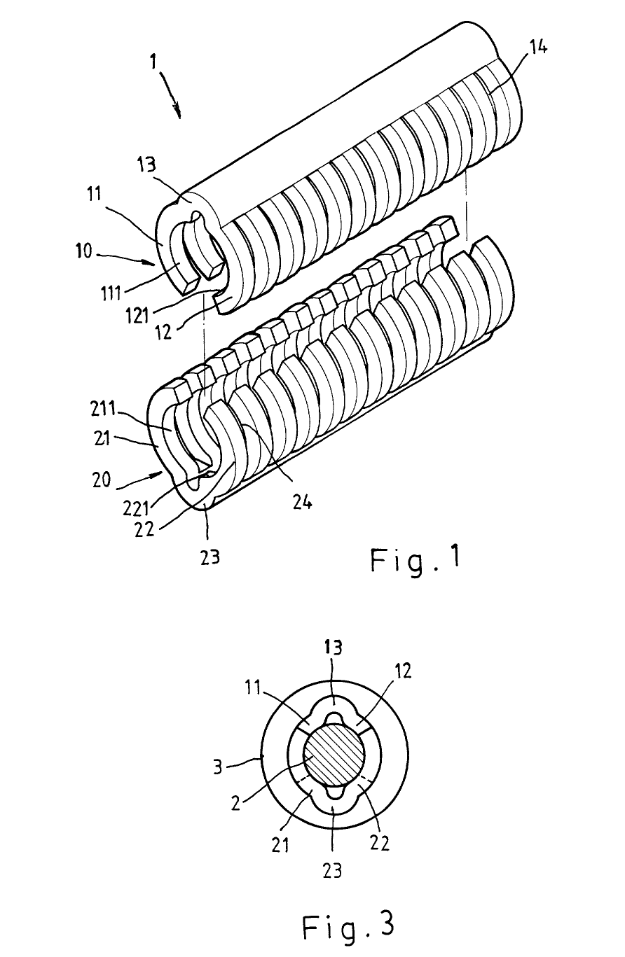

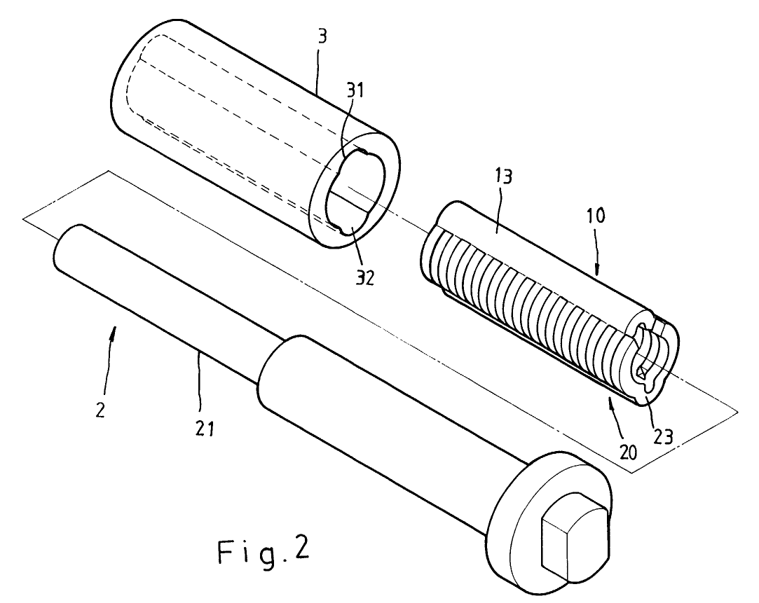

Referring to FIG. 1, the exploded perspective view of the preferred embodiment about the torsion-generating device 1 of the present invention is illustrated. The torsion-generating device 1 of the present invention includes a first retaining unit 10 and a second retaining unit 20.

The first retaining unit 10 comprises a plurality of first friction arms 11 which extend axially and are parallel to each other, and a plurality of second friction arms 12 which extend axially and are parallel to each other. Each of the first friction arms 11 is connected to the second friction arm 12 through a connecting portion 13 so as to be integrated as an integral body. By the connecting portion 13, the first retaining unit 10 can be rapidly engaged to a respective position in a sleeve 3. Furthermore, the first friction arms 11 and second friction arms 12 have arc shapes so as to form a space therebetween. Thereby, the first friction arms 11 is formed with a friction surface 111, and the second friction arms 12 is formed with a friction surface 121. Furthermore, each two adjacent first friction arms 11 and each two adjacent second friction arms 12 are formed with gaps, respectively.

Furthermore, in this embodiment, the second retaining unit 20 has the same structure as that of first retaining unit 10. The second retaining unit 20 has a plurality of first friction arms 21 and a plurality of second friction arms 22. The first friction arms 21 are connected to the second friction arms 12 through a connecting portion 23. The second retaining unit 20 has gaps 24 which can be inserted by the first friction arms 11 and the second friction arms 12 of the first retaining unit 10. Furthermore, the first and second friction arms 21, 22 of the second retaining unit may insert into the gaps 14 of the first retaining unit 10. Thereby, the first retaining unit 10 is engaged with the second retaining unit 20 (referring to FIGS. 1 and 3). Therefore, larger friction surfaces 111, 121, 211, 221 are formed so as to provide a larger torsional force.

Furthermore, in this embodiment, the first friction arms 11 and the second friction arms 12 are aligned one by one or are arranged alternatively. Furthermore, the first friction arms 12 and the second friction arms 22 are also aligned one by one or are arranged alternatively.

Referring to FIGS. 1 and 3, in assembly, the friction arms 11, 12 of the first retaining unit 10 are alternatively inserted into the friction arms 21, 22 of the second retaining unit 20 for providing a preferred torsional force and reducing the complexity in manufacturing the first retaining unit 10 and the second retaining unit 20. The first retaining unit 10 and second retaining unit 20 are combined through the connecting portions 13, 23. Then, the first retaining unit 10 and second retaining unit 20 are placed into the positions 31, 32 of the sleeve 3. The space formed by the first friction arms 11, 21 and second friction arms 12, 22 can be inserted by the axial pivot shaft 2. The outer surface of the axial pivot shaft 2 is tightly engaged to the friction surfaces 111, 121, 211, 221 of the friction arms.

When an object (not shown, for example, a liquid crystal screen of a notebook computer) installed with the axial pivot shaft 2 rotates, by the friction force between the friction surfaces 111, 121, 211, 221 of the friction arms 11, 12, 21, 22 and the outer surface of the axial pivot shaft 2 so as to provide a proper torsional force. Thereby, the object installed in the sleeve may rotate and position to a desired orientation.

Moreover, when the torsional force is necessary to be adjusted, the numbers of friction arms 11, 12, 21, 22 of the first retaining unit 10 and second retaining unit 20 can be increased or decreased so as to increase or decrease areas of the friction surfaces 111, 121, 211, 221. Thus, the object of adjusting torsional force is achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A torsion-generating device capable of being assembled with a pivot shaft device, the torsion-generating device comprising at least one first retaining unit; the first retaining unit comprising:
a plurality of first friction arms which extend axially and are parallel to each other; and a proper gap being formed between each two adjacent first friction arms; and
a plurality of second friction arms which extend axially and are parallel to each other; a proper gap being formed between each two adjacent second friction arms; and the second friction arms being arranged with respect to the first friction arms;
wherein the first friction arms and the second friction arms are connected together by a first connecting portion.

2. The torsion-generating device as claimed in claim 1, wherein each of the first friction arms and the second friction arms has an arc shape, a concave surface of the arc shape is formed with a friction surface.

3. The torsion-generating device as claimed in claim 2, wherein each of the first friction arms is aligned to each of the second friction arms.

4. The torsion-generating device as claimed in claim 2, wherein the first friction arms are alternatively arranged with the second friction arms.

5. The torsion-generating device as claimed in claim 3, further comprising a second retaining unit; the second retaining unit having a plurality of first friction arms and a plurality of second friction arms; the first friction arms of the second retaining unit being connected to the second friction arms of the second retaining unit through a second connecting portion; each two adjacent friction arms of the second retaining unit being formed with a gap which can be inserted by a respective friction arms of the first retaining unit; thereby, the first retaining unit being engaged with the second retaining unit.

6. The torsion-generating device as claimed in claim 5, wherein shape of the first retaining unit is identical to that of the second retaining unit.

7. The torsion-generating device as claimed in claim 4, further comprising a second retaining unit; the second retaining unit having a plurality of first friction arms and a plurality of second friction arms; the first friction arms of the second retaining unit being connected to the second friction arms of the second retaining unit through a second connecting portion; each two adjacent friction arms of the second retaining unit being formed with a gap which can be inserted by a respective friction arms of the first retaining unit; thereby, the first retaining unit being engaged with the second retaining unit.

8. The torsion-generating device as claimed in claim 7, wherein shape of the first retaining unit is identical to that of the second retaining unit.
